(19) United States
(12) Patent Application Publication
(10) Pub. No.: US 2006/0178048 A1
(43) Pub. Date: Aug. 10, 2006

(54) Electrical connector and method for producing the same

(76) Inventor: Ted Ju, Taipei (TW)

Correspondence Address: TED JU, P.O. BOX 26-757, TAIPEI, 106, TW

(21) Appl. No.: 11/052,518

(22) Filed: Feb. 8, 2005

(51) Int. Cl. H01R 9/05

(52) U.S. Cl. 439/579

(57) ABSTRACT

An electrical connector and a method for producing the same are described. The electrical connector is adapted for a cord, which has a plurality of copper cores and isolative layers covering the copper cores, respectively. The electrical connector has a base and a casing enclosing the base. The base has an insulative housing, which has two ends where the copper cores are secured to, and a rubbery member. The insulative housing has a hole formed in a middle thereof and receiving the rubbery member, thus the rubbery member is retained against the copper wires to force the copper cores to be raised from the insulative housing.

### BACKGROUND OF THE INVENTION

1. Field of the Invention

The present invention relates to an electrical connector and a method for producing the same, and particularly to an electrical connector adapted for cords and a method for producing the same.

2. Description of Related Art

The conventional electrical connector generally includes an insulative housing, a plurality of contacts and a metallic casing. The contacts connect to copper cores of the cords by soldering or pressing, and further are secured by insertion into the reception holes of the insulative housing. But the contacts require multiple steps in processing, such as punching for shape, soldering or pressing, and further insertion into the insulative housing. The process is inefficient and complicated, and the manual soldering process provides bad reliability.

### SUMMARY OF THE INVENTION

An electrical connector and a method for producing the same are provided for cheap and easy manufacture, simple assembly and high efficiency.

An electrical connector adapted for cords has a plurality of copper cores and isolative layers covering the copper cores. The electrical connector includes a base having an insulative housing, and a casing enclosing the insulative housing. The insulative housing has a hole formed therein, and a rubbery member disposed inside the hole. The copper cores are secured at two ends of the insulative housing and retained against the rubbery member so as to project flexibly from the insulative housing.

A method for producing the electrical connector includes: (1) removing a respective end of the isolative layers of a cable, in order to reveal the copper cores, and securing the copper cores secured to two ends of the insulative housing of a base. The insulative housing has a hole formed in a middle thereof. (2) The rubbery member is disposed inside the hole to press the copper cores to project flexibly from the insulative housing. (3) A casing is provided and secured on the base.

To provide a further understanding of the invention, the following detailed description illustrates embodiments and examples of the invention. Examples of the more important features of the invention have thus been summarized rather broadly in order that the detailed description thereof that follows may be better understood, and in order that the contributions to the art may be appreciated. There are, of course, additional features of the invention that will be described hereinafter which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a perspective view of an electrical connector with a cord according to the present invention;

FIG. 2 is a decomposition view of the electrical connected illustrated in FIG. 1;

FIG. 3 is a perspective view of the electrical connector according to the present invention during assemble; and

FIG. 4 is a cross-sectional profile of the electrical connector according to the present invention.

### DETAILED DESCRIPTION OF PREFERRED EMBODIMENTS

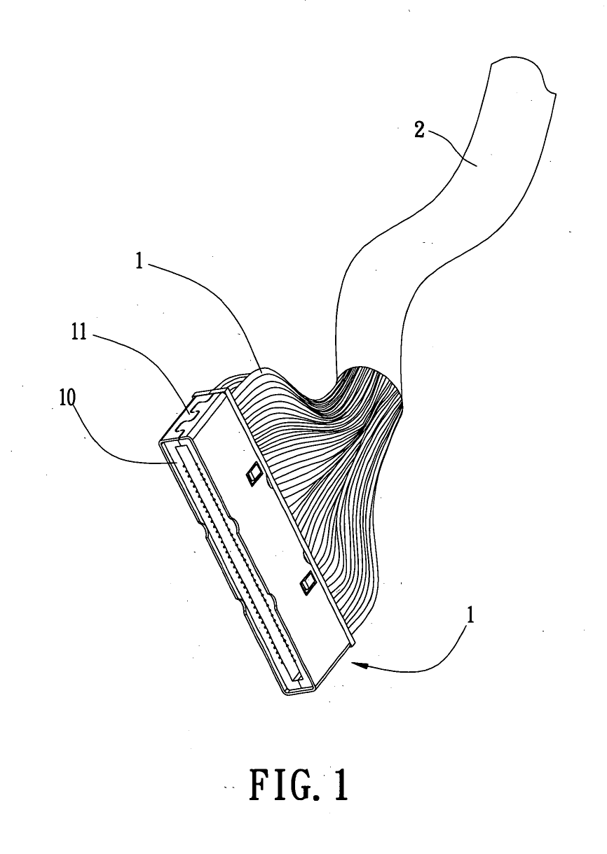

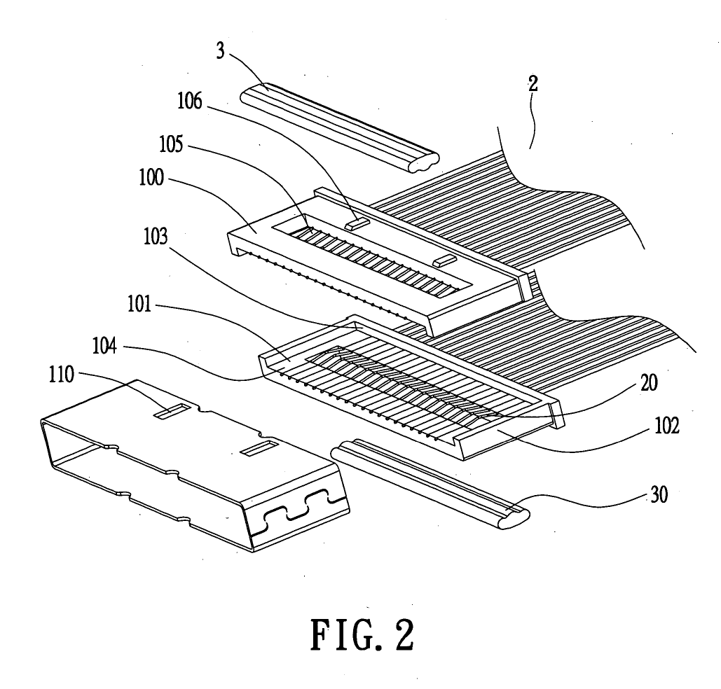

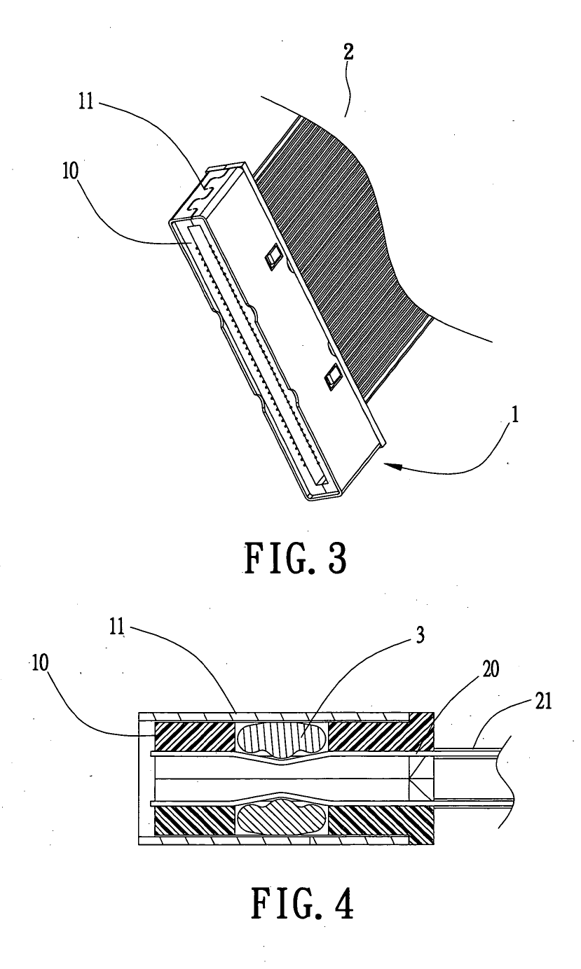

With respects to FIGS. 1 to 4, an electrical connector adapted for electrically connecting a cord 2 has a plurality of copper cores 20 and isolative layers 21 covering the copper cores 20. The electrical connector 1 includes a base 10 and a casing 11, made of metallic materials and disposed outside the base 10.

The base 10 has two insulative housings 100 in U shapes. Each of the insulative housings 100 has a surface 101, two lateral sidewalls 102 extending from two lateral sides of the surface 101, a rear 103, and a reception cavity 104 formed therein for receiving another electrical component, such as a printed circuit board or another electrical connector (not shown). In this embodiment according to the present invention, the reception cavities 104 of the two insulative housings 100 face each other, so as to form a large space.

A plurality of copper cores 20 are embedded in two ends of the insulative housing 100 by an insert-molding method. The insulative housing 100 has a hole 105 transversely formed in a middle thereof. The rubbery member 3, which is a long narrow strip, is received inside the hole 15. The rubbery member 3 is retained against the copper cores 20 inside the hole 15 to raise the copper cores 20 and protrude the copper cores 20 from the insulative housing 100 into the reception cavity 104. The rubbery member 3 has a projection 30 formed at a portion connecting to the copper cores 20; the copper cores 20 can thus be elastic.

The casing 11 has two through holes 110 relative to two protruding portions 106 of the base 10 for engaging with each other. The casing 11 encloses the base 10 to secure the two insulative housings 100, shield the elements received inside, and secure the rubbery member 3 inside the hole 105.

A method for producing the electrical connector includes: (1) removing respective ends of isolative layers 21 of a cord 2 to reveal copper cores 20. (2) The copper cores 20 are secured to two ends of an insulative housing 100, which has a hole 105 formed in middle thereof and a reception cavity 104 formed therein. (3). The rubbery member 3 can be disposed inside the hole 105 and be retained against the copper cores 20, so as to raise the copper cores 20 projected from the insulative housing 100 and inside the reception cavity 104. (4) Two insulative housings 100 are combined into a whole base 10, and the reception cavities 104 face each other. (5) A casing 11 is further enclosed the base 10.

The base 10 of the electrical connector can include only one insulative housing 100 and a rubbery member 3 relative to the insulative housing 100. The casing 11 encloses the base 10; and the method for producing the mentioned electrical connector can be processed without step (4).

It should be apparent to those skilled in the art that the above description is only illustrative of specific embodiments and examples of the invention. The invention should therefore cover various modifications and variations made to the herein-described structure and operation of the invention, provided they fall within the scope of the invention as defined in the following appended claims.

What is claimed is:

1. An electrical connector adapted for a cord, having a plurality of copper cores and isolative layers covering the copper cores, respectively, the electrical connector comprising:
a base having an insulative housing, wherein the insulative housing has two ends whereon the copper cores are secured, a rubbery member, and a hole formed in a middle thereof and receiving the rubbery member, the rubbery member being retained against the copper wires to force the copper cores to be raised from the insulative housing; and
a casing enclosing the base.

2. The electrical connector as claimed in claim 1, wherein the insulative housing has a surface, two lateral sidewalls extending from two lateral sides of the surface, a rear disposed thereof, and a reception cavity formed therein.

3. The electrical connector as claimed in claim 2, wherein the raised copper cores are inside the reception cavity.

4. The electrical connector as claimed in claim 2, wherein the base further has an additional insulative housing, wherein the additional insulative housing has an additional reception cavity, and the additional reception cavity and the reception cavity face each other to make a large space.

5. A method for producing an electrical connector adapted for a cord, the method comprising:
securing respective ends of copper cores of the cord to two ends of an insulative housing of a base, wherein the insulative housing has a hole formed in a middle thereof;
removing predetermined portions of isolative layers of the cords inside the hole, and disposing a rubbery member into the hole to press the copper cores, in order to force the copper cores to be raised flexibly; and
securing a casing to enclose the base.

6. The method as claimed in claim 5, further including:
forming providing a reception cavity in the insulative housing, and receiving the raised copper cores in the reception cavity.

7. The method as claimed in claim 5, before the casing is provided further including:
combining two insulative housings into the base, and providing two reception cavities facing each other.
